(19) United States
(12) Patent Application Publication
(10) Pub. No.: US 2022/0266800 A1
(43) Pub. Date: Aug. 25, 2022

(54) AUTOMOTIVE AIR WINDSHIELD WIPER

(71) Applicant: David W. Mayers, JR., Lynnwood, WA (US)

(72) Inventor: David W. Mayers, JR., Lynnwood, WA (US)

(21) Appl. No.: 17/676,517

(22) Filed: Feb. 21, 2022

Related U.S. Application Data
(60) Provisional application No. 63/151,064, filed on Feb. 19, 2021.

(51) Int. Cl. B60S 1/04

(52) U.S. Cl. CPC B60S 1/0477

(57) ABSTRACT

A windshield wiper system is described and comprises of a windshield wiper blade and an air system. The windshield wiper blade can connect to an existing wiper arm on a vehicle. The windshield wiper blade is configured with an air channel and a heating element. The air system includes a fan and an air hose, wherein the air system is adapted to intake air from the fan and blow air through the connected air hose into the air channel in the wiper blade. The air hose is connected to the windshield wiper blade to provide the air from the air system to the windshield wiper blade which is deposited onto the windshield to move water and debris off the windshield while the wiper arm is reciprocating the wiper blade. The heating element warms up the air moving through the air channel to melt ice and snow on the windshield.

### CROSS-REFERENCE TO RELATED APPLICATIONS

This application is a non-provisional application which claims priority to U.S. Provisional Patent Application No. 63/151,064 filed on Feb. 19, 2021, which is incorporated by reference in its entirety.

### FIELD OF THE DISCLOSURE

This present invention relates to a windshield wiper system, and more particularly to a windshield wiper system that uses air to clear a window of a vehicle.

### BACKGROUND

Windshield wipers are a standard and important feature on vehicles such as automobiles, trucks, buses, trains, and any other vehicles that includes a windshield. Windshield wipers are an important safety feature because they make a big impact on driving and overall safety by improving visibility. Windshield wipers remove rain, snow, dirt, pollen, frost, and other debris which would otherwise reduce driving visibility.

However, proper functioning wiper blades are very important to the overall driving safety. The wiper blades on the windshield wipers contact the windshield of a vehicle to clear any impediment. The conventional windshield wiper blade is designed to squeegee fluid from the windshield. Most common problems associated with the windshield wipers is that the wiper blades leave streaks, smears, or gaps of moisture or other debris on the windshield. The contact of the wiper blades on the windshield can also damage the windshield when a hard piece of debris scrapes across the glass. Additionally, the windshield wipers can crack, lose form, and lose their flexibility over time and need replacing frequently to function in good form.

Drivers also face another problem with conventional wiper blades. During cold weather, ice may buildup on the windshield, especially when the vehicle is parked outside. The conventional wiper blades are not designed to remove ice buildup on the windshield. Usually, the driver will start the vehicle and turn on the heaters so the windshield can be heated to melt the ice and subsequently clean the windshield. However, this process takes time as the vehicle needs to be turned on, the engine needs to warm up, and then the interior of the vehicle must warm up. The process is time consuming and uses up fuel which also releases exhaust into the environment. Often, the driver will manually clear the obstruction by scrubbing off the ice.

Attempts have been made to solve some of the above problems. Although there are some modern windshield wipers that have improved longevity, they still cause streaking, smearing, and gaps of moisture with the sweeping action of the wipers against the windshield. These windshield wipers may not fully and efficiently clear the windshield to improve visibility.

Accordingly, there is still an unsolved need for windshield wipers that may address these and other existing issues.

### SUMMARY

The invention described herein provides for an improved windshield wiper system that more efficiently removes liquid and solid debris from the windshield to improve visibility and increase safety.

The following paragraph generally describes how windshield wipers work. In simple terms, windshield wipers are operated by an electric motor. The electric motor is attached to a worm gear, which transmits the necessary force to a long rod that sets the wiper arms in motion. The wiper arms move the actual windshield wiper blades. The blades are generally made of rubber and must apply enough pressure to the windshield in order to remove all moisture without any streaks. The arms attach to the middle of each wiper blade, and each wiper blade has several arms that distribute the pressure onto the windshield evenly. Windshield wipers are basically the same on every car. They have two pivot points (one on the driver's side and one in the middle of the windshield) that work together to remove moisture. This is called the tandem system, and it provides the most coverage to clean the area of the windshield through which the driver looks out. There are other systems that are used; these include the single arm system (e.g., used on Mercedes vehicles) in which a single arm (controlled) system extends and retracts as it moves, and the opposed system that has pivot points on opposite ends of the windshield and the wipers move in the opposite direction

With the basic understanding of how windshield wipers operate, the present disclosure provides for a windshield wiper system for a vehicle which rides on a column of air instead of on a windshield of a vehicle. The windshield wiper system comprises of a wiper blade which has a top portion and a bottom portion. The top part of the wiper may comprise of an air channel and a heating element. The air channel receives air from a fan comprising part of the windshield wiper system and eventually directs it to the bottom portion of the wiper which may push out air from an air channel opening directly onto a windshield. The directed air is forced out to move liquid and solid debris off the windshield without the windshield wiper blade physically touching the windshield. An air hose may also comprise part of the windshield wiper system which directs the air flow from the fan to the air channel in the wiper. The fan may generate the air to be sent through the air hose to the wiper blade and is generally positioned under a hood of a vehicle within the engine compartment. A water system may also comprise part of the windshield wiper system which will send water through the air tube to the wiper to aid in cleaning the windshield. The windshield wiper system may also comprise of a heating element disposed within the top portion of the wiper blade, which is capable of being heated to warm up the air passing by toward the windshield to clear ice or snow off the windshield without having to scrape the windshield.

Other aspects and advantages of the invention will be apparent from the following description and the appended claims.

### BRIEF DESCRIPTION OF THE DRAWINGS

The present invention will be described by way of exemplary embodiments, but not limitations, illustrated in the accompanying drawings in which like references denote similar elements, and in which:

FIG. 1 is a perspective view of a wiper blade according to one or more embodiments herein.

FIG. 2 is a cross sectional view of the windshield wiper from FIG. 1 taken along line A-A.

FIG. 3 is a schematic of the windshield wiper blade adjacent a windshield on a vehicle.

FIG. 4 is a block diagram of the windshield wiper system.

### DETAILED DESCRIPTION

In the Summary above and in this Detailed Description, and the claims below, and in the accompanying drawings, reference may be made to particular features of the invention. It may be understood that the disclosure of the invention in this specification includes all possible combinations of such particular features. For example, where a particular feature may be disclosed in the context of a particular aspect or embodiment of the invention, or a particular claim, that feature can also be used, to the extent possible, in combination with and/or in the context of other particular aspects and embodiments of the invention, and in the invention generally.

Where reference may be made herein to a method comprising two or more defined steps, the defined steps can be carried out in any order or simultaneously (except where the context excludes that possibility), and the method can include one or more other steps which are carried out before any of the defined steps, between two of the defined steps, or after all the defined steps (except where the context excludes that possibility).

“Exemplary” may be used herein to mean “serving as an example, instance, or illustration.” Any aspect described in this document as “exemplary” may not be necessarily to be construed as preferred or advantageous over other aspects.

Throughout the drawings, like reference characters are used to designate like elements. As used herein, the term “coupled” or “coupling” may indicate a connection. The connection may be a direct or an indirect connection between one or more items. Further, the term “set” as used herein may denote one or more of any items, so a “set of items” may indicate the presence of only one item or may indicate more items. Thus, the term “set” may be equivalent to “one or more” as used herein.

The present disclosure recognizes the unsolved need for an improved windshield wiper system that more efficiently and effectively removes liquid and solid debris from the windshield of a vehicle to improve visibility for a driver and increase safety. Additionally, the improved windshield described herein removes the deposited debris off the windshield surface without sweeping the debris across the surface and causing damage to the windshield. The presently described windshield wiper blade also assists in faster and more efficient removal of snow and ice.

Embodiments of the present invention include a windshield wiper system comprising a pair of windshield wiper blades which are each attached to a wiper arm which in turn is connected to a linkage arm of a vehicle. The linkage arm or arms are connected to the windshield wiper motor. This assembly functions similar to the way most windshield wiper assemblies in the cars function, wherein the wiper motor operates the windshield wiper blades. An air system comprising a blower fan and an air hose may be connected to the wiper motor and may supply the compacted air to the windshield wiper blades. A control tip, which may be configured on the frame, provides for the wiper blades to be off the windshield of the car when the windshield wiper system is activated.

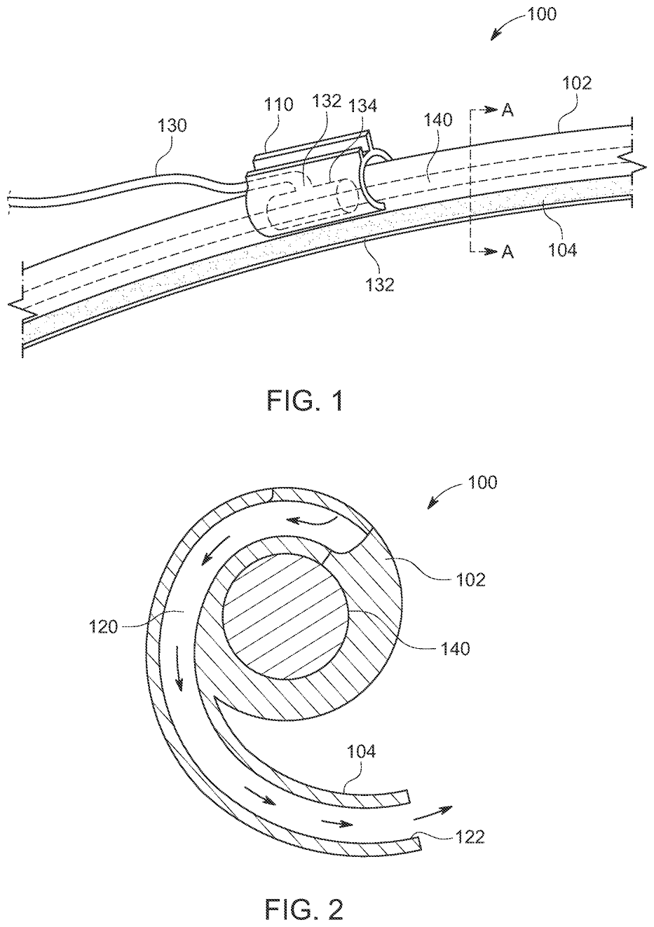

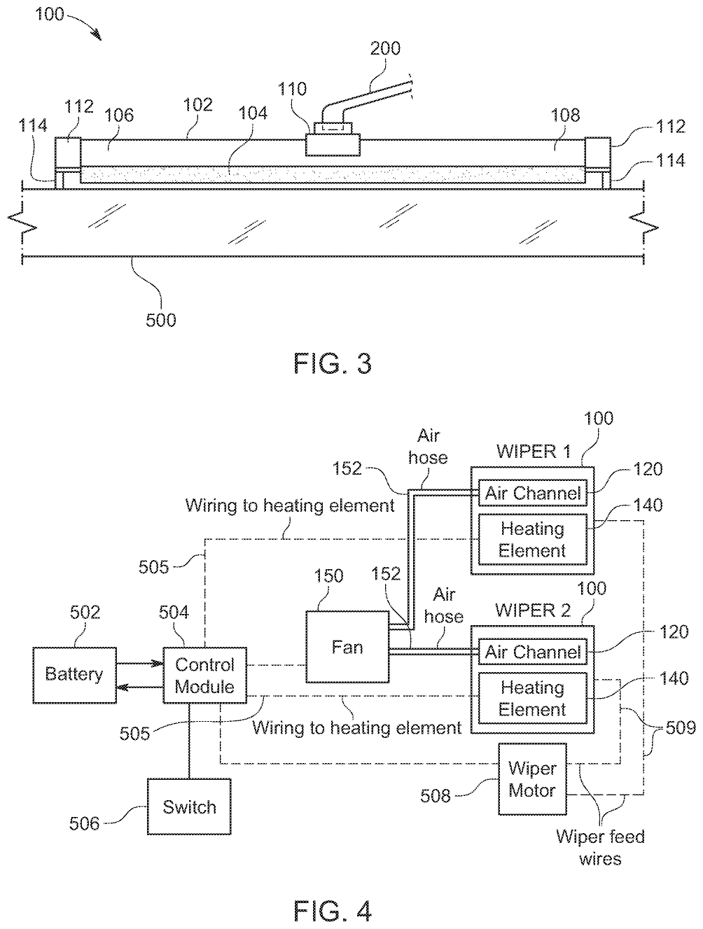

FIGS. 1-3 illustrate an example schematic of a windshield wiper blade 100 according to one or more non-limiting embodiments. FIG. 1 is a perspective view of the windshield wiper blade 100 illustrating an internal component of the windshield wiper blade 100. FIG. 2 is a cross-sectional view of the windshield wiper blade 100 of FIG. 1 taken along the line A-A. FIG. 3 is an environmental view of the windshield wiper blade 100 adjacent a windshield 500 of a vehicle. FIG. 4 illustrates a block diagram providing a schematic of the windshield wiper system including the air system and the windshield wiper blade along with their associated connections. It is to be understood that the schematics are not illustrative of the only form and shape the windshield wiper blade 100 can take. The windshield wiper blade 100 can be designed to take any appearance as long as the windshield wiper blade 100 accomplishes the function and utility of the present invention. The windshield wiper blades 100 of the present invention may have the same lengths as conventional wipers. Alternate sizes are also within the scope of the presently disclosed invention.

The windshield wiper blade 100 is adapted to be connected to an existing wiper arm or any that may be designed in the future and that is mounted to a vehicle. As discussed above, the wiper arm is operably connected to a wiper motor for reciprocating the wiper arm and thus moving the windshield wiper blade 100 across the windshield 500 of a vehicle. The windshield wiper blade 100 is configured with a heating element 140, an air channel 120, and an air channel opening 122. The windshield wiper blade 100 is configured to deliver compacted air through the air channel 120 to the air channel opening 122 onto the windshield 500 to move water and debris off the windshield 500 with the compacted air.

The windshield wiper blade 100 has a top portion 102 and a bottom portion 104. Typically, the bottom portion 104 on a standard wiper blade contacts a windshield and performs the function of a squeegee as the wiper blade is reciprocated across the windshield. The windshield wiper blade 100 of the present invention does not contact the windshield 500 and instead will ride on a column of air against the windshield that is forced out from the air channel opening 122 on the bottom portion 104. The windshield wiper blade 100 has a first and second opposing ends, 106 and 108, respectively. The first and second ends 106, 108, may each be attached to an end cap 112. The windshield wiper blade 100 also includes a connector 110 which is connected to the top portion 102 and positioned relatively at a center of the windshield wiper blade 100. The connector 110 is for removably securing the windshield wiper blade 100 to a wiper arm on a vehicle. The connector 110 is generally shown in FIGS. 1 and 3 as having a certain look and appearance, however the connector 110 may be configured in several variations to connect with different mounts on wiper arms. For example, some of the wiper arms include and are not limited to a hook mount, a side-lock mount, a top-lock mount, a pinch-tab mount, a bayonet mount, a slim-top mount, etc. Alternatively, the windshield wiper blade 100 may not include a connector 110 but may comprise of an adaptor mount (not shown) configured and positioned relatively at a center of the windshield wiper blade 100. The adaptor mount mounts to an adaptor which fits with a particular wiper arm. Thus, a user may choose the right adaptor to fit their vehicle type wiper arm.

The windshield wiper blade 100 includes the heating element 140 and the air channel 120. The heating element 140 is disposed within the top portion 102 of the windshield wiper blade 100. The heating element 140 may extend longitudinally within the top portion 104 and may be relatively an entire length of the windshield wiper blade 100 from the first end 106 to the second end 108. The air channel 120 is also configured longitudinally along the entire length of the windshield wiper blade 100 from the first end 106 to the second end 108. The air channel 120 may be configured adjacent to the heating element 140 to heat air that is pushed into the air channel 120. The air channel 120 extends around the heating element 140 in the top portion 102 and into the bottom portion 104 to open toward the windshield 500, indicated as the air channel opening 122.

The air that is pushed into the air channel 120 exits out from the air channel opening 122 to be deposited onto the windshield 500. The compacted air removes water, debris, and any buildup from the windshield 500. As the windshield wiper blade 100 is reciprocated by the wiper arm 200, the air movement out from the air channel opening 122 moves the water, debris, and any buildup on the windshield 500. Additionally, in cold climates, the heating element 140 may be utilized to warm up the air entering the air channel 120 to help eliminate or greatly reduce icy buildup on the windshield 500. The heating element 140 converts electrical energy from the battery (see FIG. 4, battery 502) into heat. The heat generated by the heating element 140 warms up the air entering the air channel 120, as the air is immediately adjacent the heating element 140, and thus melts any ice or snow formed on the windshield 500. The wiper blade 100 of the present invention eliminates having to manually clean the windshield of ice and snow. Additionally, using compacted air as the medium to remove water and debris off the windshield also prevents any streaks from forming, which can happen when a standard wiper blade acts as a squeegee on the windshield.

As clearly seen in FIG. 2, the windshield wiper blade 100 is shown to be formed in the shape of the letter “e”, wherein the upper part of the “e” is the top portion 102 and the lower part of the “e” is the bottom portion 104. As mentioned, it is to be understood that the windshield wiper blade 100 can have a shape that accommodates the functionality and utility of the present invention. The top portion of the “e” shaped windshield wiper blade 100 is integrated with the heating element 140. The longitudinal air channel 120 is shown to be configured around the top portion 102, or the upper portion of the “e” and wraps around a side of the “e” and continues toward the lower part of the “e” to the air channel opening 122 which is at an end point of the lower part of the “e” to direct air outward to the windshield 500.

Referring to FIG. 1 and FIG. 4, the windshield wiper blade 100 may also comprise of a center support 134 located within the top portion 102 adjacent to where the connector 110 connects to the wiper blade 100. The center support 134 is a hollow tubular piece which has an opening 132 that traversers through the top portion 102 of the wiper blade 100. The opening 132 also traverses through the connector that is connected to the top portion 102. A tube 130 is connected to the opening 132 which brings wires to the heating element 140 (See FIG. 4, wiring to heating element 505). The connection of the tube 130 to the opening is a sealed and connected so that air and water does not leak out or into the connection, respectively. The wires 505 bring electrical energy from the battery 502 to the connected heating element 140. Additionally, the tube 130 also brings air from a fan 150 through an air hose 152. The air hose 152 is connected to the fan 150 which may be positioned anywhere under a hood of a vehicle where the fan 150 can take in air. As can be seen in FIG. 1, the center support 134 wraps around a portion of the heating element 140 and the air channel 120. The center support 134 may be a length of the connector 110 or relatively similar in length to permit the air and wire 505 connection to the air channel 120 and the heating element 140, respectively. In one or more alternative embodiments, the windshield wiper blade may not comprise of the heating element 140. In such an embodiment, the air hose 152 may directly connect to the opening 132 in the center support and requiring a tube 130. However, it is to be understood that the tube 130 may be used in this embodiment to direct the air hose to the air channel 120.

Referring to FIG. 4, like most windshield wiper systems, a wiper motor 508, through electric wires 509, controls the reciprocating motion of the presently disclosed windshield wiper blade 100. Embodiments of the presently disclosed windshield wiper blade 100 may be connected to the fan 150 which may comprise of an air intake feature and air blower. The fan 150 is connected to the air channel 120 through the air hose 152 which sends air to the air channel 120 in the windshield wiper blade 100. Each windshield wiper blade 100 indicated as Wiper 1 and Wiper 2 in FIG. 4, is connected to the air hose 152. The windshield wiper blade 100 may also be fitted onto a rear windshield and thus would have an air hose 152 connected to it from the fan 150. The air hose 152 and the wiring 505 to the heating element may be disposed within the tube 130 (See, FIG. 1) that connects to the wiper blade 100. The tube is adapted to contain these elements and be connected to the wiper blade 100. A user or a car mechanic may align the tube 130 along the wiper arm between the hood of the car and the opening 132 in the connector 110 and the center support 134. The air tubes 152 subsequently push air out to the air channel 120 in the wiper blade 100, out through the air channel opening 122 onto the windshield 500.

One or more control tips 114, as shown in FIG. 3, also comprise part of the windshield wiper blade 100 of the present invention. The one or more control tips 114 may be integrated on the end caps 112 connected on to the first and second opposing ends 106, 108, respectively. The one or more control tips 114 may also be integrated anywhere along the length of the wiper blade 100, as long as the one or more control tips 114, when the windshield wiper blades are reciprocating, rest against the windshield 500 (FIG. 3). When the wiper motor (See, FIG. 4 Wiper motor 508) is activated, the wiper arms and the wiper blades 100 are reciprocating along the windshield 500, the control tip 114 keeps the wiper blade 100 off the windshield 500 a certain distance so as to permit the air to move through the air channel 120 and out of the air channel opening 122 to move liquid and other debris off the windshield without the windshield wiper blade touching at the windshield 500. It is also to be understood that in an alternate embodiment, the windshield wiper blade 100 will not comprise of one or more control tips 114 and will appropriately distance itself from the windshield 500 when air is pushed against the windshield 500 from the windshield wiper blade 100. The wiper blade 100 in both embodiments will not be touching the windshield 500 during operation and will be distanced from the windshield 500 at a distance of 0.001 to 0.003 inches.

Referring to FIGS. 1-4, the operation of the windshield wiper blade 100 is now described. The heating element 140 in the windshield wiper blade 100 receive DC voltage from a vehicle's battery 502 the windshield wiper blade 100 is installed on. The battery 502 delivers power to the heating element 140 through a control device, such as a manually operable switch 506, which is typically installed in a driver's compartment in the vehicle. The switch 506 can also power the fan 150 to draw in air and blow the air through the air hose 152 to the wiper blades 100. The switch powers the wiper motor 508 to reciprocate the wiper arms and thus the wiper blade 100. It is to be understood that this is the most basic setup to operate the windshield wiper blade 100. These wiper blades 100 can also be set up to function with an automatic switch assembly as is common in most vehicles.

The windshield wiper blade 100 can be installed on an existing wiper arm. The connector 110 can be attached to the wiper arm or an adaptor may be used that conforms to fit the wiper arm. The fan 150 can be mounted under a hood, in an engine compartment of a vehicle. As seen in FIG. 4, the wiring from the fan 150 can be routed to connect with an under the hood control module 504. Wiring from the heating element 140 can also be routed and connected to the control module 504. The switch to control the function of the wiper blade 100 can be mounted within a driver compartment in the vehicle. The air hose 152 and the wiring to the heating element 505 can be routed to their respective elements along the wiper arm of a vehicle using the tube 130, shown in FIG. 1.

The advantages of the windshield wipers of the present invention are their effectiveness at cleaning liquid, solid debris, ice, and snow off the windshield without the standard scrubbing. Utilizing air to remove these deposits, the present wipers eliminate the streaks that may form from scrubbing the windshield which also obstruct a driver's view. Additionally, utilizing air also removes the debris without scratching the glass surface of the windshield. Other advantages also include the longevity of the wiper blade due to minimal or no scrubbing which obviates expediated wear and tear on a wiper blade. With the advantageous usage of air and the heating element in the novel wiper blade, a driver may remove ice and snow without manually having to scrape and wipe their windshield. The heated air would melt the ice and snow and subsequently push the deposit off by the compressed air. It should be understood that the embodiments of the present invention are effective and can be incorporated for any vehicle that uses a windshield wiper or can benefit from the usage of a windshield wiper.

The corresponding structures, materials, acts, and equivalents of any means or step plus function elements in the claims below are intended to include any structure, material, or act for performing the function in combination with other claimed elements as specifically claimed. The description of the present invention has been presented for purposes of illustration and description but is not intended to be exhaustive or limited to the invention in the form disclosed. Many modifications and variations will be apparent to those of ordinary skill in the art without departing from the scope and spirit of the invention.

The embodiments were chosen and described in order to best explain the principles of the invention and the practical application, and to enable others of ordinary skill in the art to understand the invention for various embodiments with various modifications as are suited to the particular use contemplated. The present invention, according to one or more embodiments described in the present description, may be practiced with modification and alteration within the spirit and scope of the appended claims. Thus, the description is to be regarded as illustrative instead of restrictive of the present invention.

What is claimed is:

1. A windshield wiper system comprising:
a windshield wiper blade having a top portion and a bottom portion, wherein the windshield wiper blade is configured with an air channel; and
an air system including a fan and an air hose, wherein the air system is adapted to intake air from the fan and blow air through the connected air hose, wherein the air hose is connected to the windshield wiper blade to provide the air from the air system to the windshield wiper blade.

2. The windshield wiper system of claim 1, wherein the air channel is configured along a longitudinal length of the windshield wiper blade from a first end to a second end.

3. The windshield wiper system of claim 1, wherein the air channel has an air channel opening on the bottom portion along a longitudinal length of the windshield wiper blade from a first end to a second end.

4. The windshield wiper system of claim 3, wherein the air channel is configured in the top portion and extends down into the bottom portion of the windshield wiper blade to the air channel opening.

5. The windshield wiper system of claim 1, wherein the air hose is connected to the top portion of the windshield wiper blade, wherein a center support is disposed within the top portion and positioned relatively at a center point of the windshield wiper blade, and wherein the top portion and the support have an opening to which the air hose is connected.

6. The windshield wiper system of claim 1, wherein the windshield wiper blade is adapted to push away from a vehicle's windshield when the air system is activated.

7. The windshield wiper system of claim 6, wherein one or more control tips are connected to the windshield wiper blade, wherein the one or more control tips abut against the windshield with the bottom portion distanced from the vehicle's windshield to create space for the air from the air channel opening to deposit onto the windshield.

8. The windshield wiper system of claim 7, wherein the one or more control tips are connected to a first end and a second end of the windshield wiper blade.

9. The windshield wiper system of claim 6, wherein the air exiting the air channel in the bottom portion pushes against the vehicle's windshield and moves the windshield wiper blade away from the vehicle's windshield.

10. A windshield wiper system comprising:
a windshield wiper blade having a top portion and a bottom portion, wherein the windshield wiper blade is configured with an air channel and a heating element; and
an air system including a fan and an air hose, wherein the air system is adapted to intake air from the fan and blow air through the connected air hose, wherein the air hose is connected to the windshield wiper blade to provide the air from the air system to the windshield wiper blade.

11. The windshield wiper system of claim 10, wherein the air channel is configured along a longitudinal length of the windshield wiper blade from a first end to a second end, and the heating element is disposed within the windshield wiper blade along the longitudinal length of the windshield wiper blade from the first end to the second end.

12. The windshield wiper system of claim 10, wherein the air channel has an air channel opening on the bottom portion along a longitudinal length of the windshield wiper blade from a first end to a second end.

13. The windshield wiper system of claim 12, wherein the heating element is disposed in the top portion of the windshield wiper blade and the air channel is configured in the top portion around the heating element and extends down into the bottom portion of the windshield wiper blade to an air channel opening.

14. The windshield wiper system of claim 10, wherein a center support is disposed within the top portion and disposed relatively at a center point of the windshield wiper blade, wherein the center support has an opening which coincides with an opening in the top portion, and wherein a tube is connected to the opening in the top portion and the center support.

15. The windshield wiper system of claim 14, wherein the air hose and a wiring for the heating element are connected to the tube so that the air hose delivers air to the air channel, and the wiring for the heating element is connected to the heating element.

16. The windshield wiper system of claim 10, wherein the windshield wiper blade is adapted to push away from a vehicle's windshield when the air system is activated.

17. The windshield wiper system of claim 16, wherein one or more control tips are connected to the windshield wiper blade, wherein the one or more control tips abut against the windshield with the bottom portion distanced from the vehicle's windshield to create space for the air from the air channel opening to deposit onto the windshield.

18. The windshield wiper system of claim 17, wherein the one or more tips are connected to a first end and a second end of the windshield wiper blade.

19. The windshield wiper system of claim 16, wherein the air exiting the air channel in the bottom portion pushes against the vehicle's windshield and moves the windshield wiper blade away from the vehicle's windshield.
